(19) United States
(12) Patent Application Publication
(10) Pub. No.: US 2015/0297004 A1
(43) Pub. Date: Oct. 22, 2015

(54) DISPOSABLE SET OF DISHES COMPRISING A LAMINATE

(71) Applicant: Pedram ZOLGADRI, München (DE)

(72) Inventor: Pedram ZOLGADRI, München (DE)

(21) Appl. No.: 14/646,475

(22) PCT Filed: Oct. 23, 2013
(86) PCT No.: PCT/EP2013/072216

§ 371 Date: May 21, 2015

(30) Foreign Application Priority Data
Nov. 21, 2012 (DE) 10 2012 111 235.5

(51) Int. Cl. A47G 19/03; B32B 37/12; B32B 38/00; B32B 37/18

(52) U.S. Cl. CPC A47G 19/03; B32B 37/182; B32B 37/12; B32B 38/0012; B32B 2439/00

(57) ABSTRACT

The present invention relates to disposable tableware comprising a laminate comprising at least one dewaxed plant leaf or piece thereof, an adhesive and a bioplastic film. Moreover, the invention relates to methods to produce such a laminate.

### FIELD OF THE INVENTION

The present invention relates to disposable tableware comprising a laminate comprising at least one dewaxed plant leaf or piece thereof, an adhesive and a bioplastic film. In addition, the invention provides methods for producing such a laminate.

### BACKGROUND OF THE INVENTION

The use of plastic packaging has significantly increased in recent decades. Plastic packaging offers protection against moisture and dirt, ensures hygiene, an attractive appearance and protects the packaged goods from abuse at comparatively low material usage.

7 billion people on this planet ensure that raw material prices of plastic rise by 10 to 14% annually. Each year, 266 million tons of plastic are used worldwide. It is estimated that today six times more plastic particles than plankton swim in the oceans of the world. Plastic parts and their decomposition products accumulate, particularly in some vortices, and lead to a significant compression in some marine regions. Plastic waste drifting in the seas is already torn relatively quickly into very small scraps reaching an ever-increasing degree of fineness up to pulverisation over time. With a high degree of fineness the plastic powder is, however, taken up as food by various sea creatures and, among others, also by plankton. Starting with the plankton plastic particles containing toxic and cancer-causing chemicals such as DDT and polychlorinated biphenyls continue to accumulate in the food chain. Plastic waste with the accumulated toxins thus also finds its way to food for human consumption. Plastic waste is an internationally known environmental problem—not only in the oceans.

Disposal of these materials has meanwhile turned out to be a problem growing in the same way. Recycling systems evolve only slowly, have a questionable effectiveness and are often only implemented regionally, for example in Germany. In addition, crude oil as natural starting material of thermoplastic polyolefin plastics is limited. These circumstances result in the basic need of new appropriate packaging materials made from renewable raw materials that can be disposed of in an environmentally friendly way.

In the state of the art (e.g. DE 603 13 679 T2) biodegradable and particularly compostable containers are known that can keep items in a dry, moist or wet condition. Such containers often have the disadvantage that they are relatively expensive to manufacture due to several ingredients and therefore very costly. Furthermore, the addition of wood components is often required for the production of packaging materials known in the state of the art, which needlessly drives deforestation due to the high numbers. Even after the addition of wood components such containers still often tend to be brittle and less flexible.

### SUMMARY OF THE INVENTION

The inventors have invented a new multi-layered packaging material that is inexpensive to manufacture, suitable for use in the microwave and pliable and can be safely used for food packaging. Furthermore, it is characterised by the fact that it may be preferably disposed of in an environmentally friendly way, has a smooth surface and/or is thermoformable.

The invention relates in one aspect to a laminate comprising
(i) at least one plant leaf or a piece thereof
(ii) an adhesive; and
(iii) a bioplastic film which includes a polyhydroxycarboxylic acid or a copolymer thereof;
   wherein the bioplastic film is connected with at least one portion of the top of the plant leaf or piece thereof via the adhesive; and wherein the bioplastic film has a thickness of 40 μm-600 μm (preferably at least 100 μm).

The invention relates in another aspect to disposable tableware comprising or consisting of a laminate comprising
(i) at least one dewaxed plant leaf or a piece thereof
(ii) an adhesive; and
(iii) a bioplastic film which includes a polyhydroxycarboxylic acid or a copolymer thereof;
   wherein the bioplastic film is connected with at least one portion of the top of the dewaxed plant leaf or piece thereof via the adhesive; and wherein the bioplastic film has a thickness of 40 μm-600 μm.

In another aspect the invention relates to a method for producing a laminate comprising the steps:
(i) one-sided application of an adhesive to the surface of a bioplastic film;
(ii) contacting the surface of the pre-treated plant leaves or pieces thereof with the adhesive side of the adhesive-coated bioplastic film
(iii) producing the laminate by pressing the adhesive-coated bioplastic film with the pre-treated plant leaves or pieces thereof; and
(iv) Optionally cutting the laminate
   Wherein the bioplastic film includes a polyhydroxycarboxylic acid or a copolymer thereof; and wherein the plant leaves, the adhesive and the bioplastic film has a texture as defined herein.

In another aspect the invention relates to a method for producing a laminate comprising the steps:
(i) pre-treatment of plant leaves or pieces thereof by contacting the leaves or pieces thereof with alkaline liquor with a soap solution and/or with an organic solvent;
(ii) one-sided application of an adhesive to the surface of a bioplastic film;
(iii) contacting the surface of the pre-treated plant leaves or pieces thereof with the adhesive side of the adhesive-coated bioplastic film;
(iv) production of the laminate by pressing the adhesive-coated bioplastic film with the pre-treated plant leaves or pieces thereof; and
(v) optionally cutting the laminate
   wherein the bioplastic film includes a polyhydroxycarboxylic acid or a copolymer thereof; and the bioplastic film has a texture as defined herein.

Another aspect according to the invention is a laminate that can be produced by means of a method according to the invention.

### DETAILED DESCRIPTION OF THE INVENTION

All references cited in this specification document of any kind are incorporated in their entirety by reference herein.

Some terms which are used in this specification are defined in the following. The usual definitions of the state of the art apply to all other terms.

The term “container” as used herein shall include any container or vessel for packaging, storing, shipping, serving, portioning or dispensing various types of products or objects (both solids and liquids) regardless of whether such use is intended for a short-term or long-term period. Containers within the handling of the present invention may or may not be labelled as disposable articles. “Containers” can be, for example, bowls, cups, mugs, plates and trays.

“Disposable tableware” is understood to mean a container or serving device (e.g. plate or tray), preferably for food. Cutlery such as knives and forks is preferably no “disposable tableware”. “Disposable tableware” preferably comprises containers that can hold dry, moist and wet products. Disposable tableware that is suitable for holding dry materials can be used to contain dried fruits or raw nuts such as almonds. Disposable tableware that is suitable for holding moist materials can be used to hold fruits and vegetables such as fresh mushrooms or tomatoes and should be capable of performing this function for at least two to three weeks as the normal packaging-to-consumption time amounts to around 14 days. Disposable tableware for moist foods can also be used for hot fast-food products such as French fries or Hamburgers, in which case the container must only hold the moist food for a short period of time, for example, for one hour after entering the moist food. Disposable tableware for moist foods can also be used in combination with an absorbent pad for the packaging of raw meat. In this case, the container should withstand contact with meat for a period of seven days or longer and may desirably withstand at least one freeze/thaw cycle. If possible, this package should be able to withstand microwaves. Suitable for moist foods, disposable tableware of the invention is preferably able to take a hot liquid, such as a soup bowl, a cup of coffee or another food product, for a period of time sufficient to consume before cooling, for example, within one hour after purchase. Such containers may also be used to hold a dry product that is rehydrated with hot water, such as cup soup products. In such embodiments the leaves have an advantageous thermally insulating effect and thus, for example, allow touching disposable tableware according to the invention with a hot or cold content. In a preferred embodiment disposable tableware is fully biodegradable.

According to the European standard EN 13432, a material may be referred to as “readily biodegradable” if, after 180 days, at least 90 per cent of the organic carbon were decomposed by microorganisms. A material is “partially biodegradable” as defined in this specification if, after 180 days, more than 10 per cent and less than 90 per cent of this material was decomposed.

“Waxes” include higher molecular weight fatty acids (e.g. C24-C36) that are esterified with a higher molecular weight (e.g. C16-C36), mono or polyvalent fatty acids. “Waxes” also include other lipophilic substances, in particular a Shorea robusta (Sal) plant leaf or a Bauhinia Vahlii (Siali) plant leaf in the cuticle of a plant leaf.

The verbs “pre-treat” and “dewax” are preferably used as synonyms herein.

Laminate is understood to mean a material or product comprising two or more surface layers that are glued together.

“Animal glue” is natural glue that has long been known in the state of the art and which is obtained from animal waste of higher animals by boiling. In preferred embodiments “animal glue” according to the invention is added sufficient casein to make it waterproof.

A “paste” is an adhesive that is well known in the state of the art. It is preferably a normal paste on starch basis or based on modified cellulose ether (most preferably based on methyl cellulose).

“Bioplastic” is preferably a thermoplastic polymer that is partially and preferably completely biodegradable.

The bonding of a bioplastic film containing a polyhydroxycarboxylic acid such as polylactic acids (short PLA), with plant leaves is advantageous because the resulting laminate has a higher strength than its constituent parts. In particular, among other things, puncture resistance improvement is achieved. At the same time, the quantity of expensive bioplastic film can be saved without reducing the material strength. Both the leaves and the bioplastic film pose no health risk, so that the laminate meets the hygienic requirements for packaging e.g. foods. However, the bonding of leaves with bioplastic film is not trivial as the material properties of the plant leaf differ from the material properties of the polyhydroxycarbolic acid-containing bioplastic film. Although the bioplastic film thickness can be reduced by bonding with the leaves, the film must not bee too thin as they may otherwise tear in use and/or be too flexible, which can lead to flaking of the hardened adhesive.

Cuticle in botany refers to a protective layer consisting of wax that rests on the outer walls of epidermal cells of leaves. It protects the plant tissue, inter alia, from loss of water.

It has been found that a sufficient adhesion effect can be obtained when the bonding takes place on the upper leaf surface wherein the leaves have been pre-treated prior to bonding in order to remove at least a portion of the wax in the cuticle. Bonding on the upper leaf surface offers the advantage that the upper surface provides a smoother surface which facilitates and improves uniform bonding. If the bioplastic film has a thickness of 40 μm-600 μm and preferably of 150 μm-400 μm, the resulting laminate is sufficiently stable and rigid in order to allow a stable bond. By pre-treating the leaves they are cleaned at the same time, whereby the resulting laminate is also suitable in order to be, for example, used in disposable tableware due to its ecological and health-safe materials.

For these reasons a first aspect of the invention relates to disposable tableware comprising or consisting of a laminate comprising
(i) at least one dewaxed plant leaf or piece thereof
(ii) an adhesive; and
(iii) a bioplastic film which includes a polyhydroxycarboxylic acid or a copolymer thereof;
   wherein the bioplastic film is connected with at least one portion of the top of the dewaxed plant leaf or piece thereof via the adhesive and wherein the bioplastic film has a thickness of 40 μm-600 μm and preferably of 150 μm-400 μm and most preferably of 250 μm-300 μm. The film thickness is preferably determined in accordance with DIN 53370.

If the disposable tableware comprises several superimposed layers of leaves, they can optionally be connected (e.g. sewn together or glued). However, this is not mandatory as, surprisingly, the leaves alone can assume a specific form and maintain it for a long time after compression. Thus, it is sufficient, in preferred embodiments, when each leaf is connected to the bioplastic film via the adhesive at least in one point.

In a preferred embodiment, the dewaxed plant leaf or piece thereof is a plant leaf or a plant leaf piece from which wax is preferably partially or completely removed from the cuticle by pre-treatment with alkaline liquor, soap solution and/or an organic solvent. Aqueous KOH or NaOH solution can be used as alkaline liquor. Preferably alkaline liquor containing 1-10% KOH or NaOH is used. An aqueous (e.g. 2%-10%) soap solution can be used as soap solution. Soaps are sodium or potassium salts of fatty acids. The organic solvent is preferably a C6-C8 alkane (especially hexane) or a C1-05 alcohol, such as ethanol, methanol and isopropanol. The organic solvent need not be present in pure form but the above-mentioned organic solvents may also be used diluted with water (e.g. 70% organic solvent in water based on the final volume) to dewax the leaves. A further advantage of dewaxing is that the leaves are also cleaned from microorganisms, which is desirable for sanitary reasons.

In general, any plant leaf can be used in the disposable tableware according to the invention. However, it surprisingly turned out that certain plant leaves form a very stable laminate with the bioplastic film and, at the same time, are also suitable to permanently adopt a new form after pressing. This makes it possible to save valuable bioplastic film so that a thinner film can be used. These leaves are still not too thick and not too hydrated which facilitates processing and drying. The leaves are still stress-resistant and have a specific resin content, which makes it possible to give the leaves an own form by pressing. If these leaves are pressed into a form as laminate with the bioplastic film using an adhesive, this form is maintained by both the leaves and the preferably thermoplastically deformed bioplastic film.

For this reason, in particularly preferred disposable tableware according to the invention, the dewaxed plant leaf or apiece thereof is a leaf or a leaf piece of a plant of the genus Shorea (e.g. Shorea robusta (Sal)) or Bauhinia (e.g. Bauhinia Vahlii (Siali). However, other plant leaves or pieces thereof can also be used optionally: for example: palm leaves, bamboo leaves, seaweed, hemp leaves, flax leaves, cotton leaves (linum xylinum), grass leaves (e.g. herba or gramen), Saccharum officinarum (sugar cane) and/or reed leaves. A slightly thicket bioplastic film is preferably used for these leaves, e.g. one with a thickness of 210 μm-600 μm.

A particularly stable laminate is obtained if the bioplastic film and leaves structurally support each other and maintain their shape. For this purpose, in a preferred embodiment of the invention of the disposable tableware, the dewaxed plant leaf and/or piece thereof has a surface area of at least 10 cm². Preferably each of the plant leaves contained in the disposable tableware according to the invention has a surface area of at least 300 cm² and pieces thereof a surface area of at least 10 cm².

It is also advantageous if the laminate of the invention comprises several dewaxed plant leaves or pieces thereof, wherein the dewaxed plant leaves or pieces thereof partially overlap. Preferably, the overlap is scaly. Preferably, however, at least 40%, 50%, 60%, 70%, 80% o rat least 90% (most preferably at least 80%) of the surface of each of the dewaxed plant leaves or pieces thereof are connected with the bioplastic film through the adhesive despite the overlap.

In a further preferred embodiment, the bioplastic film is at least partially biodegradable. In this embodiment, the bioplastic film can additionally comprise a plastic which is not a polyhydroxycarboxylic acid. In one embodiment, the bioplastic film comprises between 10 wt.-% to 90 wt.-% of such a plastic material and preferably 50%-60% of such a plastic material. Preferred plastics are selected from the group consisting of recycling plastic, polyester, polyethylene, polypropylene, polyvinyl chloride, polystyrene, polyurethane, polyethylene terephthalate and polymethyl methacrylate. By adding one of these polymers, the flexibility, durability and the glass transition temperature of the bioplastic film can be increased or adjusted. In a most preferred embodiment, the bioplastic film is fully biodegradable.

A further preferred embodiment relates to disposable tableware according to the invention, wherein the polyhydroxycarboxylic acid is selected from the group of polymers consisting of PLA (polylactic acid), polymer of glycolic acid, polymer of 3-hydroxybutyric acid, polymer of 4-hydroxybutyric acid, polymer of 4-hydroxyvaleric acid, polymer of 5-hydroxyvaleric acid, polymer of 6-hydroxycaproic acid, poly (3-hydroxybutyrate), poly (3-hydroxyvalerate) and copolymers of said polyhydroxycarboxylic acids.

The use of PLA in the bioplastic film is preferred. Most preferably the bioplastic film comprises or consists of PLA. The advantages of a PLA film begin already in the manufacturing process that consumes between 30 to 50 per cent less fossil fuel than the production of conventional materials. In addition, less carbon dioxide is released into the atmosphere, where it is used again for the growth of new cornstarch. The use of this raw material is thus largely CO₂ neutral. A PLA film is fully biodegradable by reacting mainly into carbon dioxide and water with the help of microorganisms. Polylactic acids exclusively built up from lactic acid units are preferred. Particularly PLA homopolymers are preferred herein which contain 80-100 wt.-% L-lactic acid units, corresponding to 0 to 20 wt.-% D-lactic acid units. In order to reduce crystallinity, even higher concentrations of D-lactic acid units may be contained as comonomer. If desired, the polylactic acid may comprise additional polyhydroxy acid units as comonomer differing from lactic acid such as glycolic acid units, 3-hydroxypropanoic acid units, 2,2-dimethyl-3-hydroxypropanoic acid units or higher homologues of the hydroxycarboxylic acids with up to 5 carbon atoms.

Preference is given to lactic acid polymers with a melting point of 110 to 170° C., preferably 125 to 165° C., and a melt flow index (measured according to DIN 53735 at 2.16 N load and 190° C.) of 1 to 50 g/10 min, preferably of 1 to 30 g/10 min, in particular 1-6 g/10 min. The molecular weight of the PLA is in a range of at least 10,000 to 500,000 (number average), preferably 50,000 to 300,000 (number average). In a particularly preferred embodiment of the disposable tableware according to the invention, the polyhydroxycarboxylic acid has a weight average molecular weight of 140,000-160,000.

The glass transition temperature Tg of the bioplastic film is preferably within a range of 40 to 120° C., preferably 50 to 85° C. The measurement of the glass transition temperature is preferably determined with the help of the known in the art Dynamic Mechanical Analysis (DMA) or the dynamic differential scanning calorimetry (DSC). In addition, the bioplastic film can contain conventional additives such as neutralising agents, stabilisers, antistatic agents and/or lubricants in effective quantities.

It is clear that the laminate according to the invention may also comprise more than one bioplastic film. In a preferred embodiment, at least one dewaxed plant leaf or apiece thereof is arranged between two bioplastic films in the laminate of the disposable tableware of the invention (see, for example, Illustration 1B). Multi-layer bioplastic films can also be preferably used in the laminate of the invention.

Also preferred is disposable tableware according to the invention, wherein the laminate comprises a plurality of dewaxed plant leaves or pieces thereof, wherein the dewaxed plant leaves or parts thereof partially overlap and/or wherein the bioplastic film is not arranged at any point between two superimposed leaves. In other words, the bioplastic film is preferably not located between the layers of leaves but is glued to the leaves as form-supporting and preserving outer layer. The bioplastic film, for example, may slow fading of the leaves and maintain the attractive appearance of the laminate (see also below).

The roughness of the lower leaf surface may interfere with the bonding process and possibly lead to bubble inclusions and/or an uneven surface. Thus, disposable tableware according to the invention is particularly preferred, wherein the bioplastic film is not glued to the underside of at least one dewaxed plant leaf or piece thereof. In another embodiment, however, the bioplastic film can also be glued to the underside of the leaf.

Since many bioplastic films are attached by certain solvents, disposable tableware according to the invention is preferred wherein the adhesive does not contain solvent selected from the group acetic acid n-propyl ester, acetic acid ethyl ester, acetic acid n-butyl ester, butanone, toluene, xylene, N-methyl-2-pyrrolidone.

A particularly effective and thus preferred adhesive which can be contained in disposable tableware according to the invention is selected from the group consisting of Epotal P100 ECO, synthetic resin dispersion glue, gelatine, casein glue, starch, animal glue, paste and glyoxal. Here, a dispersion of polyvinyl acetate in water is preferably used as synthetic resin dispersion adhesive. The aforementioned adhesives are particularly suitable for the different materials, namely to glue leaf and bioplastic film.

If disposable tableware according to the invention comprises or consists of a laminate according to the invention, which is made of a transparent bioplastic film, adhesive and leaves, such disposable tableware produces an aesthetic effect with the observer as the leaf colour and leaf structure are clearly visible through the smooth and shiny bioplastic film and give the disposable tableware an attractive appearance.

However, if the disposable tableware is exposed to sunlight for longer periods of time, the natural colour of the leaves may partly fade as bioplastic film containing only a polyhydroxycarboxylic acid can be relatively transparent to UV light. Fading can make disposable tableware less attractive for the buyer and thus reduce the sales of products packaged or offered therein.

Fading can be significantly reduced if the adhesive is added polyunsaturated alkenes, aromatics or heteroaromatics as additives, which is particularly preferred. In a further particularly preferred embodiment, the adhesive comprises at least 10 weight per cent based on the total weight of the adhesive of an organic compound, which is selected from the group consisting of purine, pyrimidine, tyrosine, histidine, tryptophan and phenylalanine. These additives also reduce fading. Such additives may preferably be omitted if the adhesive is selected from the group consisting of gelatine, casein glue and animal glue as these protein-based adhesives already include aromatic amino acids. In a further preferred embodiment, the adhesive comprises as an additive a food dye (e.g. chlorophyll (E 140), copper-containing complexes of chlorophylls and chlorophyllin (E 141) and/or Green S (E 142)).

Disposable tableware according to the invention preferably comprises or consists of a laminate that is sterile, water-resistant, biodegradable and/or thermoformable.

If the laminate can be deformed thermoformably, the glass transition and the melting temperature of the bioplastic film can be increased due to a higher molecular weight of the polyhydroxycarboxylic acid and thus specifically adapted to the desired product properties. An increase of the melting temperature is desirable, for example, in the event that the disposable tableware should be suitable for microwaves.

The following embodiments of the laminate are particularly preferred:

| | Bioplastic film | | |
|---|---|---|---|
| | comprising or | | |
| Embodiment | consisting of | Adhesive | Plant leaf |
| a | PLA | Epotal P100 ECO | Shorea robusta (Sal) |
| b | PLA | Synthetic resin | Shorea robusta (Sal) |
| | | dispersion adhesive | |
| c | PLA | Gelatine | Shorea robusta (Sal) |
| d | PLA | Casein glue | Shorea robusta (Sal) |
| e | PLA | Starch | Shorea robusta (Sal) |
| f | PLA | Animal glue | Shorea robusta (Sal) |
| g | PLA | Paste | Shorea robusta (Sal) |
| h | PLA | Glyoxal | Shorea robusta (Sal) |
| i | PLA | Epotal P100 ECO | Bauhinia Vahlii (Siali) |
| j | PLA | Synthetic resin | Bauhinia Vahlii (Siali) |
| | | dispersion adhesive | |
| k | PLA | Gelatine | Bauhinia Vahlii (Siali) |
| 1 | PLA | Casein glue | Bauhinia Vahlii (Siali) |
| m | PLA | Starch | Bauhinia Vahlii (Siali) |
| n | PLA | Animal glue | Bauhinia Vahlii (Siali) |
| o | PLA | Paste | Bauhinia Vahlii (Siali) |
| p | PLA | Glyoxal | Bauhinia Vahlii (Siali) |

Another aspect of the invention relates to the production method of a laminate which can be used, for example, in disposable tableware according to the invention.

Another aspect of the invention relates to a method for producing a laminate according to the invention comprising the steps:
(i) pre-treatment of plant leaves or pieces thereof by contacting the leaves or pieces thereof with alkaline liquor, soap solution and/or an organic solvent;
(ii) one-sided application of an adhesive to the surface of a bioplastic film;
(iii) contacting the surface of the pre-treated plant leaves or pieces thereof with the adhesive side of the adhesive-coated bioplastic film
(iv) producing the lamination by pressing the adhesive-coated bioplastic film with the pre-treated plant leaves or pieces thereof; and
(v) optionally cutting the laminate
   wherein the bioplastic film includes a polyhydroxycarboxylic acid or a copolymer thereof; and wherein the plant leaves, the adhesive and the bioplastic film preferably show the characteristics described herein.

In step (i) preferably dried, e.g. sun-dried leaves are used as starting material. An aqueous KPH or NaOH solution can be used as alkaline liquor in step (i). Preferably alkaline liquor is used which contains 1-10% KOH or NaOH. An aqueous (e.g. a 2%-10%) soap solution can be used as soap solution. Soaps are sodium or potassium salts of fatty acids. The organic solvent is preferably a C6-C8 alkane (especially hexane) or a C1-05 alcohol, such as ethanol, methanol and isopropanol. The organic solvent need not be present in pure form but the abovementioned organic solvents may also be used diluted with water (e.g. 70% organic solvent in water based on the final volume) to dewax the leaves.

If an alkaline liquor is used, the leaves in step (i) are preferably treated in aqueous NaOH or KOH liquor with a concentration of between 2 g/1 and 50 g/1, at a temperature of between 80° C. and 120° C. for at least 5 seconds preferably under 2-30 bar pressure.

If an organic solvent is used, the leaves are preferably treated in 70% alcohol at an elevated temperature between 80° C. and 90° C. for at least 2 seconds in step (i) of the inventive process to produce the laminate.

In the event that a soap solution is used, the leaves and pieces thereof can be pre-treated in a 20-50° C. warm aqueous soap solution for at least 1 minute. The concentration of the soap solution can be freely chosen as long as dewaxing is achieved.

The one-sided application of the adhesive to the bioplastic film in step (ii) may be carried out process well known in the state of the art. Step (ii) is carried out in a preferred embodiment in a spraying method. If the entire surface of the bioplastic film is coated with adhesive, this is particularly advantageous for large-scale manufacturing processes as the adhesive-coated film can be brought into contact with loose leaves and leaf pieces in step (iii) one or more times until the individual leaves and leaf pieces preferably cover the entire surface of the film. This can be done, for example, by unwinding the bioplastic film from a roll coated with the adhesive in a continuous process and then brought into contact with the leaves as long as the entire film surface is connected to the leaves through the adhesive.

In step (iii), the leaves are preferably brought into contact with the adhesive-coated bioplastic film after pre-treatment in a still wet state. This reduces the risk of breaking or tearing the leaves in the following pressing process (iv).

The pre-treated plant leaves and pieces thereof are extensively placed on the bioplastic film in step (iii).

A further preferred embodiment relates to the process for producing a laminate according to the invention wherein in step (iv) compressing includes a plastic deformation of the laminate at elevated temperature and under the action of pneumatic forces or by mechanical action of moulding tools or by combination of pneumatic and mechanical forces. Plastic moulding using pneumatic forces can take place using pneumatic forces by negative pressure (thermoforming) or overpressure, i.e. compressed air. Such processes are known as in the state of the art and described in the English language as “thermoforming” The processes and their embodiment in detail are described, for example, in Rosato's Plastics Encyclopedia and Dictionary, which are explicitly incorporated herein by reference. In moulding temperature and overpressure or negative pressure and/or mechanical force through the moulding tool cause adhesion between the surface of the pre-treated plant leaves or pieces thereof and the surface of the bioplastic through the adhesive. The bioplastic film can, for example, be thermoformed with vacuum, compressed air/vacuum or in the compressed air process. To improve the removal of water vapour at the pressing process in step (iv) the mould can be lined either with a porous material which is permeable to water vapour or a plurality of individual vent holes through which water vapour can escape.

The temperature of the mould can also affect the surface texture of the laminate. If a mould is hotter than the matching mould part, experience has shown that the vapour rather migrates to the colder mould. As a result, the surface of the laminate will be smoother and more uniform relative to the hotter surface than the surface relative against the colder surface. It is thus preferred than in process step (iv) compressing constitutes compression moulding in which the mould facing the bioplastic film has a higher temperature than that which is in contact with the leaves.

In a preferred embodiment, the bioplastic film has a glass transition temperature or a melting point of between 85 and 110° C. At this temperature the leaves are simultaneously best formable and pressable. If the bioplastic film contains or consists of PLA, the glass transition temperature and the melting point can be adjusted by selecting the weight average molecular weight of the PLA accordingly. A higher molecular weight increases the glass transition and the melting temperature, tensile strength and the e-modulus and decreases elongation at break. An increase of the melting temperature can also be achieved by the addition of PDLA (poly-D-lactide) or other polymers in the bioplastic film.

Preferably compression takes place with a press in which either the forming die or its counterpart is heated, the temperature of the heating is preferably adjusted so that the glass transition temperature of the bioplastic film is reached during the pressing process. Preferably step (iv) takes between 10 seconds to 1 hour wherein compression preferably takes places in a press in which either the forming die and/or its counterpart is heated.

To increase the durability of the moulding of the laminate and to avoid cracks in the leaves of the plant leaves, the pressing is preferably carried out under heat and in particular at 80-110° C. For this purpose, a press can be used which comprises a heat device which is suitable to heat the surface and/or lower surface of the laminate during the pressing process.

A plasma treatment is also suitable to allow the surface of the leaves improved bonding. Thus, in a further aspect the invention relates to a method for producing a laminate comprising the steps:
(i) pre-treatment of plant leaves or pieces thereof by treatment with a plasma, e.g. by flame treatment;
(ii) one-sided application of an adhesive to the surface of a bioplastic film;
(iii) contacting the top of the pre-treated plant leaves or pieces thereof with the adhesive side of the adhesive-coated bioplastic film
(iv) producing the laminate by pressing the adhesive-coated bioplastic film with the pre-treated plant leaves or pieces thereof; and
(v) optionally cutting the laminate
   wherein the bioplastic film includes a polyhydroxycarboxylic acid or a copolymer thereof; and wherein the plant leaves, the adhesive and the bioplastic film have a texture as defined herein.

Another aspect relates to the production of a laminate comprising the steps:
(i) thermoforming the bioplastic film by means of a thermoforming process;
(ii) coating the underside (preferably the side which later does not come in contact with food) of the moulded bioplastic film with an adhesive;
(iii) contacting the adhesive-coated and formed bioplastic film with preferably pre-treated leaves and/or leaf pieces with the adhesive side of the bioplastic film;
(iv) compressing the product from (iii); and
(v) optional: drying and/or cutting of the laminate obtained (iv);
   wherein the bioplastic film includes a polyhydroxycarboxylic acid or a copolymer thereof; and wherein the plant leaves, the adhesive and the bioplastic film have a texture as defined herein.

Two more aspects of the invention relate to disposable tableware or the laminate of the present invention, wherein the plant leaf or piece thereof is not dewaxed. Another aspect of the invention is a production process of such disposable tableware or laminate. These aspects can be combined with the abovementioned preferred embodiments, except that the leaves are not pre-treated and non-dewaxed.

Another aspect of the invention is a laminate that can be produced by one of the manufacturing methods according to the invention described herein.

### DESCRIPTION OF THE FIGURES

FIG. 1A

Cross-sectional view through a preferred embodiment of a laminate of the present invention. The plant leaves are connected via the adhesive with the bioplastic film. If several layers are used in leaves or pieces thereof, these can be connected mechanically or chemically. For example, the leaves or pieces thereof may be glued or stitched together.

FIG. 1B

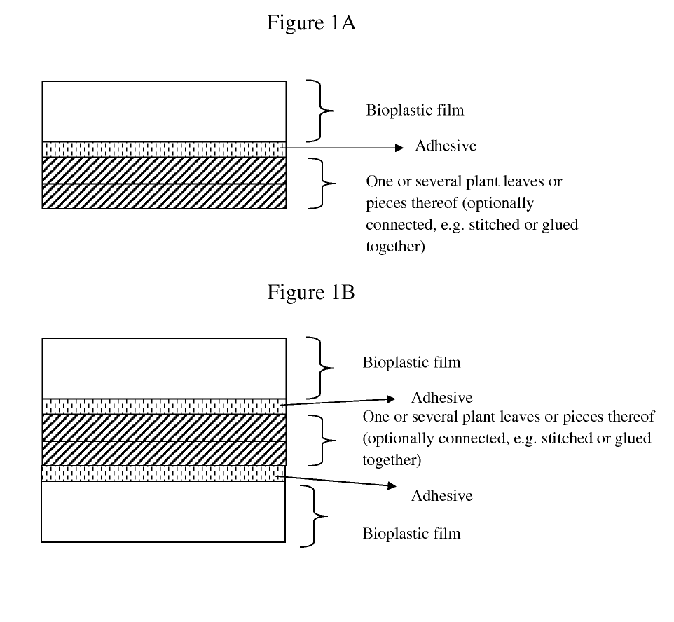

Cross-sectional view through a preferred embodiment of the laminate of the present invention. An embodiment is shown in which the preferably dewaxed plant leaf or piece thereof is arranged between two bioplastic films.

### EXAMPLES

The following examples are set forth to teach preferred compositions and process conditions for making the laminates of the invention or of the disposable tableware according to the invention. However, the examples should not be constructed to indicate that they limit aspects described herein or embodiments in any way.

### Example 1

### Pre-Treatment of the Leaves by Means of Alkaline Cleaning

By this method, both impurities as well as fats and waxes of the leaf surface are largely removed by means of a leaching process. This pre-treatment of the leaves is carried out by washing and using alkaline solutions. The efficiency of the method is probably based on a swelling and emulsification in particular of the hydrophobic substances. Thus, a portion of the fats and waxes is removed from the surface, which can improve the resistance of a later bonding, in particular with a polyhydroxycarboxylic acid-contained film.

Dried leaves (or other materials stated herein) are immersed in aqueous 5% NaOH solution having a temperature of about 80° C. for 60 seconds. The duration of impact of the lye on the leaves is limited to 10 seconds in this example.

Then the caustic soda is washed off with cold water from the leaves.

### Example 2

### Pre-Treatment of the Leaves by Means of Organic Solvent

In this example, dried leaves are washed in a solution of 90% isopropanol in water at room temperature (20° C.-25° C.) for 10 seconds. The efficiency of the method is based on a particular extraction of hydrophobic substances from the cuticle. This treatment can also improve the resistance of a subsequent bonding in particular with a polyhydroxycarboxylic acid-contained film.

### Example 3

### Pre-Treatment of the Leaves by Means of Polyethylenimine

The plant leaves were pre-treated according to Example 1 or 2 are sequentially immersed in 10% aqueous polyethylenimine (MW 2000) solution and then briefly rinsed with distilled water.

### Example 4

Bauhinia Vahlii and Shorea Robusta leaves are pre-treated according to one of the Examples 1-3. A 50 μm thick bioplastic film of poly-L-lactic acid (PLA) is coated with a 30% aqueous gelatine solution as an adhesive. The pre-treated leaves are then placed on the adhesive-coated film and pressed overnight under a pressure of 1 kg/cm² and then dried for one day at 60° C.

Following the process the leaves stick to the film and form a solid laminate together. A thus obtained composite film also has a good surface gloss. Optionally, drying can also be carried out in the press.

If the laminate is stored for 2 months in compost at 40° C., the laminate will thus largely decompose and the remaining material will be easily crushable.

### Example 5

Bauhinia Vahlii and Shorea Robusta leaves are pre-treated in accordance with the Examples 1-3. An adhesive of cationic resin glue and alkyl ketene dimers according to embodiment Example 4 of DE 19 522 832 A1 is used in order to coat a 100-μm thick bioplastic film of poly-L-lactic acid (PLA L-shape). The pre-treated leaves are adhered to the adhesive side of the PLA film to produce a laminate in which the leaves strongly stick to the bioplastic film and pressed overnight at room temperature under a pressure of 5 kg/cm² and then dried for 1 day at 60° C.

### Example 6

In another example, the procedure is as in Example 5 except that a saturated aqueous casein solution or a pre-gelled starch suspension is used as adhesive. Starch of about 2.5-15% strength (based on the weight of the pre-gelled starch suspension), such as potato or cornstarch, and from about 85-97.5% water (based on the weight of the pre-gelled starch suspension) is used as pre-gelled starch suspension. The pressing and simultaneous drying take place at 85° C. for 30 minutes at a pressure of 1 kg/cm².

### Example 7

A laminate according to the invention can also be obtained in one of the Examples 1-3 Bauhinia Vahlii and/or Shorea robusta leaves adhered with PLA film according to Example 5, wherein a normal starch-based adhesive paste or adhesive paste based on modified cellulose ether (preferably based on methyl cellulose) is used. This conventional paste is known in the state of the art and commercially available. Drying does not take place at 60° C. but at room temperature (20°-25° C.).

### Example 8

A laminate in which the leaves are glued between two bioplastic films is produced by pressing a second bioplastic film that is pre-coated with adhesive to the backside of the leaves following Example 4-7. In a time-efficient method, the sandwich is prepared first of two bioplastic films and the leaves and then pressed in one step.

### Example 9

For the manufacture of disposable tableware which comprises a container made from a laminate according to the invention only the bioplastic film is, in a first step, brought into the desired shape by means of a method known as thermoforming in the state of the art.

In a second step, the lower surface (preferably the side which does not come into contact with food later) of the moulded bioplastic film is coated with an adhesive according to one of the Examples 4-7. In a third step, leaves which have been preferably pre-treated in accordance with one of the embodiment Examples 1-3 are applied to the adhesive side of the bioplastic film and the result is pressed overnight at room temperature under a pressure of 5 kg/cm² into a form that corresponds to the container shape. After drying the finished moulded laminate is obtained.

### Example 10

In another manufacturing method for obtaining a disposable tableware comprising a container made from the laminate according to the invention, the bioplastic film is coated according to any of Examples 4-7 with adhesive and leaves in a first step. Care is taken that the leaves partially overlap after application of the leaves to the film.

In a further step a laminate is obtained in a forming pressing process. This pressing process is carried out at a forming temperature a little above the glass transition temperature so that the bioplastic film permanently assumes the new form. In this example, a 100 μm bioplastic film of a 40:60 mixture of polylactic acid with polymethyl methacrylate as copolymer (40 parts by weight of the polylactic acid and 60 parts by weight of the polymethyl methacrylate) are used whose glass transition temperature amounts to approx. 75° C. The temperature of the moulding tool is adjusted for pressing at 80° C. In the 5-minute pressing process the leaves are simultaneously placed in the laminate in a pressing process type in the same form. After drying at 50° C. for 1 hours and optional trimming of the laminate the finished shaped laminate vessel is obtained.

1. Disposable tableware comprising or consisting of a laminate comprising
(i) at least one dewaxed plant leaf or a piece thereof
(ii) an adhesive; and
(iii) a bioplastic film which comprises a polyhydroxycarboxylic acid or a copolymer thereof;
wherein the bioplastic film is connected to at least one portion of the upper surface of the dewaxed plant leaf or a piece thereof via the adhesive;
and wherein the bioplastic film has a thickness of 40 μm-600 μm.

2. Disposable tableware according to claim 1, wherein the dewaxed plant leaf or piece thereof is a plant leaf or plant leaf piece from which wax is preferably partly or completely removed from the cuticle by pre-treatment with alkaline liquor, soap solution and/or an organic solvent.

3. Disposable tableware according to claim 1 or 2,
wherein the dewaxed plant leaf or piece thereof is a leaf or leaf piece of a plant of the genus Shorea (e.g. Shorea robusta (Sal)) or Bauhinia (e.g. Bauhinia Vahlii (Siali)).

4. Disposable tableware according to claim 1, wherein the dewaxed plant leaf and/or part thereof has a surface of at least 10 cm².

5. Disposable tableware according to claim 1, wherein the polyhydroxycarboxylic acid is selected from the group of polymers consisting of PLA (polylactic acid), polymer of glycolic acid, polymer of 3-hydroxybutyric acid, polymer of 4-hydroxybutyric acid, polymer of 4-hydroxyvaleric acid, polymer of 5-hydroxyvaleric acid, polymer of 6-hydroxycaproic acid, poly (3-hydroxybutyrate), poly (3-hydroxyvalerate) and copolymers of the above polyhydroxycarboxylic acids.

6. Disposable tableware according to claim 1, wherein the laminate comprises several dewaxed plant leaves or pieces thereof, wherein the dewaxed plant leaves or pieces thereof partly overlap and/or wherein the bioplastic film is not positioned at any point between two superimposed leaves.

7. Disposable tableware according to claim 1, wherein the bioplastic film is not glued to the lower surface of at least one dewaxed plant leaf or piece thereof.

8. Disposable tableware according to claim 1, wherein the adhesive is selected from the group consisting of Epotal P100 ECO, synthetic resin dispersion glue, gelatine, casein glue, starch, animal glue, paste and glyoxal.

9. Disposable tableware according to claim 1, wherein the adhesive contains at least 10 weight per cent based on the total weight of the adhesive of an organic compound, which is selected from the group consisting of purine, pyrimidine, tyrosine, histidine, tryptophan and phenylalanine.

10. Disposable tableware according to claim 1, wherein the laminate is sterile, waterproof, biodegradable and/or thermoformable.

11. Method to produce a laminate according to claim 1 comprising the steps:
(i) pre-treating plant leaves or pieces thereof by contacting the leaves or pieces thereof with alkaline liquor and/or an organic solvent;
(ii) one-sided application of an adhesive to the surface of a bioplastic film;
(iii) contacting the surface of the pre-treated plant leaves or parts thereof with the adhesive side of the adhesive-coated bioplastic film
(iv) producing the laminate by compressing the adhesive-coated bioplastic film with the pre-treated plant leaves or pieces thereof; and
(v) optionally cutting the laminate
wherein the bioplastic film comprises a polyhydroxycarboxylic acid or a copolymer thereof.

12. Method to produce a laminate according to claim 11, wherein in step (i) the leaves are treated in aqueous NaOH or KOH liquor with a concentration of between 2 g/I and 50 g/I, at a temperature between 80° C. and 120° C. for at least 5 seconds preferably under 2-30 bar pressure.

13. Method to produce a laminate according to claim 11, wherein in step (i) the leaves are treated in 70% alcohol preferably at an elevated temperature between 60° C. and 90° C. for at least 2 seconds.

14. Method to produce a laminate according to claim 11, wherein in step (iv) compressing includes a plastic deformation of the laminate at an elevated temperature and under the effect of pneumatic forces or by mechanical action of moulding tools or by a combination of pneumatic and mechanical forces.

15. Laminate producible according to a method of claim 11.
